(19) United States
(12) Patent Application Publication
(10) Pub. No.: US 2008/0016437 A1
(43) Pub. Date: Jan. 17, 2008

(54) Method and System for Modifying and Presenting Document Data

(76) Inventors: Joachim Fenkes, Boeblingen (DE); Gerhard Hellner, Schonaich (DE); Tobias Warner, Schoenbuch (DE); Pascal Witte, Stuttgart (DE)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/689,555

(22) Filed: Mar. 22, 2007

(30) Foreign Application Priority Data
Jul. 17, 2006 (DE) 06117279.7

(51) Int. Cl. G06F 17/00; G06F 3/048

(52) U.S. Cl. 715/227; 715/212; 715/833; 715/786

(57) ABSTRACT

A computer-implemented method and program product of modifying and presenting document data (150). Sub-elements (180) of document elements (TA) are marked as “fixed” elements. When the document data is presented in a visible document area of a computer program processing the document, the fixed elements are presented as long as their associated document elements are presented at least partially. An example for a document element is a table (TA), and its sub-elements can be table headers (180), table rows, and table columns. The associated data used for the presentation are called sliding table headers (430), sliding rows, and sliding columns.

### BACKGROUND OF THE INVENTION

The present invention relates to a method and system for modifying and presenting document data, especially for spreadsheet documents and documents containing tables.

A spreadsheet is a rectangular table (or grid) of information, often financial information. It refers to a worksheet providing a two way analysis of accounting data (e.g., an accounting matrix in which the columns and rows constitute either debit and credit sides respectively or reverse). Computer programs implementing a spreadsheet on a computer are called spreadsheet programs.

Spreadsheet programs can be used to tabulate many kinds of information, not just financial records, so the term “spreadsheet” has developed a more general meaning as information presented in a rectangular table, usually generated by a computer. Many different spreadsheet programs are available on the market today. The most common type of spreadsheet programs offers representations in form of two-dimensional matrices for the spreadsheet data. The elements in the matrices are called cells, and the two-dimensional matrices are called tables.

IPCOM000031506D describes a method for providing sensitive information for cells in a table. The sensitive information is a textual or graphical message that is displayed based on the position of a mouse pointer on the computer screen. This method eliminates the need for a computer user to change the visible area of a table on a computer screen by use of scrollbars or keys of computer keyboard in order to display the message content as part of the visible area of the table. It also causes less strain to the eyes of a human computer user as they do not have to move their focus from table headers to an actual cell and vice versa.

Often spreadsheet programs and programs displaying tables allow quickly sorting and filtering rows in tables. So rows that are filtered out are not displayed on the computer screen. The sorting of rows allows to further control the rows that are currently displayed in a visible document area. IPCOM000032412D describes a related way of controlling the visible table area, wherein inline latching controls are provided for table headers as well as subsets of table headers in form of column header groups.

Spreadsheet documents can be embedded in other data representations. For example, it is possible to embed entire spreadsheet programs that are implemented as program objects within other computer programs using technologies like CORBA (Common Object Request Broker Architecture), COM (Common Object Model) including ActiveX, or JavaBeans. This way it is possible to present multiple spreadsheet documents and therefore multiple tables on a computer screen at once. However, by simply embedding multiple spreadsheet documents the different spreadsheets cannot be controlled all at once by use of a single scrollbar.

The data contained in spreadsheet documents can also be exported as table data described in data formats for inclusion in other document types. Examples are document types used by word processing or desktop publishing programs, which mostly support tables. A typical example are formats based on markup languages, which allow to combine text and extra information about the text, e.g., information about the text structure or presentation, which is intermingled with the primary text. Widely used markup languages are HTML (HyperText Markup Language) and XML (Extensible Markup Language). Both HTML and XML support tables.

When presenting multiple spreadsheets and/or tables at once, it is desirable to have the table headers remain at a fixed position while the subset of a spreadsheet document or table data presented in a visible area on a computer screen is moved row by row.

### SUMMARY OF THE INVENTION

It is therefore an object of the present invention to provide a method for modifying and presenting document data that is improved over the prior art and a corresponding computer program method and computer program product, and a corresponding computer system.

This object is achieved by the invention as defined in the independent claims. Further advantageous embodiments of the present invention are defined in the dependent claims.

Some subsets of said document data are marked as document elements, and for some of said document elements some of their subsets are marked as sub-elements. This way a document structure is established. The advantages of the present invention are achieved by marking sub-elements of document elements as “fixed”.

When document data is presented in a visible document area of a computer program processing the document, the fixed elements are presented as long as their associated document elements are presented at least partially. An example for a document element is a table, and its sub-elements can be table headers, table rows, and table columns. The associated data used for the presentation are called sliding table headers, sliding rows, and sliding columns. Instead of marking a sub-element as fixed directly, this marking can also be performed indirectly by defining certain attributes of sub-elements as causing a “fixed” marking.

A method in accordance with the invention comprises the following steps:
marking some sub-elements as fixed elements;
selecting at least some document data for presentation;
for every document element, determining if it is at least partially selected;
if a document element is at least partially selected, determining if it comprises a fixed element and determining if this comprised fixed element is completely selected; if said comprised fixed element is not completely selected, creating a sliding element; completely selecting said sliding element instead of any part of said comprised fixed element; and
presenting the selected data, whereby a presentation of a sliding element comprises a complete presentation of the associated fixed element.

For the step of selecting document data for presentation, it is not required to rely on the document structure. Therefore, the step, wherein it is determined for every document element if it is at least partially selected, can be separated from the step of selecting document data for presentation.

In an embodiment of the invention, the sub-elements of a document can be marked as fixed interactively by a computer user. It is also possible that the marking is controlled automatically by a computer program. Further, the marking of fixed elements can be stored persistently in the document in a non-volatile computer memory.

In another embodiment of the invention, at least a subset of a computer program implementing a method in accordance with the present invention is stored in the document itself. For example, JavaScript code can be embedded within HTML documents comprising table data. A browser program processing the HTML document is then presenting sliding table headers as long as a part of a table is presented in a window of the browser program.

### BRIEF DESCRIPTION OF THE DRAWINGS

The present invention and its advantages are now described in conjunction with the accompanying drawings.

FIG. 1 is a block diagram illustrating the concept of the visible document area.

FIG. 2 is a block diagram of a spreadsheet program window.

FIG. 3 is a block diagram of a browser window.

FIG. 4 is a block diagram of a sequence illustrating a change of a visible document area over time in accordance with the invention.

FIG. 5 is a block diagram of a sequence illustrating a change of a visible document area over time in accordance with the invention.

FIG. 6 is a block diagram of a sequence illustrating a change of a visible document area over time in accordance with the invention.

FIG. 7 is a block diagram of a flow chart for a method in accordance with the invention.

FIG. 8 is a block diagram of a document representation in accordance with the invention.

FIG. 9 Is a block diagram of a document representation in accordance with the invention.

FIG. 10 is a block diagram of a document representation in accordance with the invention.

FIG. 11 is a block diagram of a sequence illustrating a change of a visible document area over time in accordance with the invention.

FIG. 12 is a block diagram of a sequence illustrating a change of a visible document area over time in accordance with the invention.

FIG. 13 is a block diagram of a system in which certain embodiments may be implemented.

### DETAILED DESCRIPTION OF THE INVENTION

### Introduction

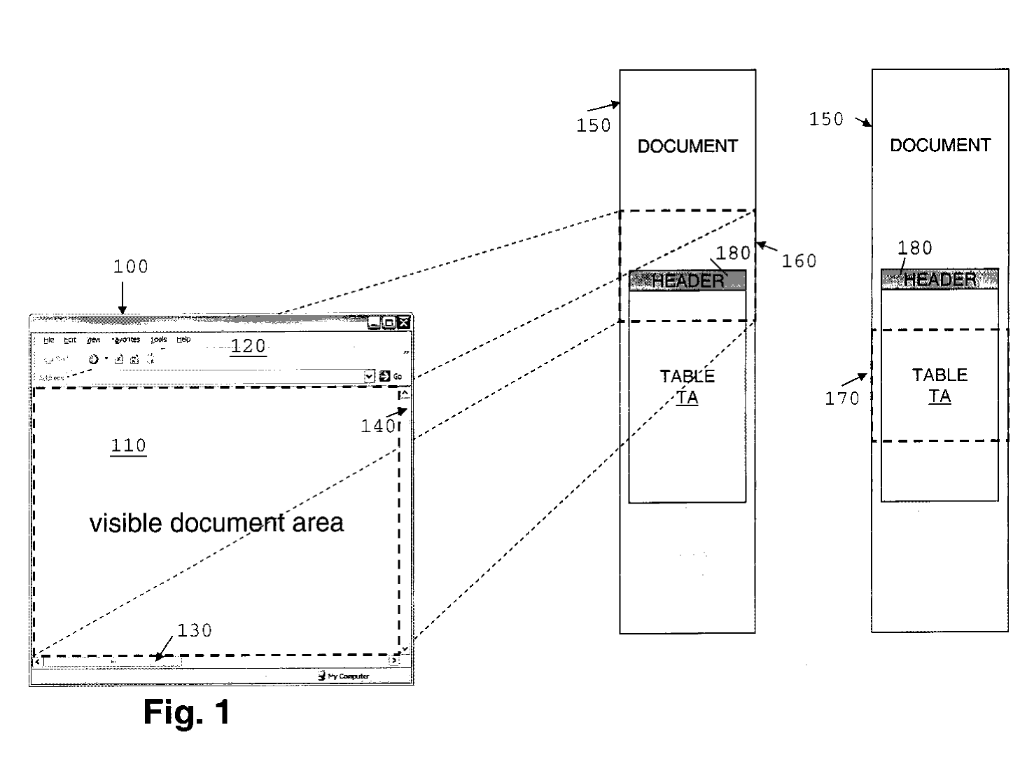

FIG. 1 illustrates a spreadsheet program that offers a graphical user interface to the spreadsheet in window 100. A particular collection of spreadsheet data maintained by a spreadsheet program is called a spreadsheet document, or simply a document. The window 100 comprises a document area 110 and a control area 120. The document area 110 presents the actual spreadsheet data and the control area 120 offers additional control elements that allow controlling the execution of the spreadsheet program.

A computer screen has always a maximum screen resolution, for instance 1400×1200 pixels. So the available area on a computer screen is fixed. There are also usability aspects that prevent the usage of the full resolution for the presentation of graphical information to a human viewer. Therefore, the complete spreadsheet data can often not be presented in the document area 110 as there is simply not enough space. In that case, the document area 110 is called the visible document area. The scrollbars 130 and 140 located in the control area 120 allow controlling the subset of the spreadsheet data that is presented in the document area 110. Scrollbar 130 allows moving the visible document area between the spreadsheet columns, and scrollbar 140 allows moving between the spreadsheet rows. Therefore, scrollbar 130 is also called a horizontal scrollbar, and scrollbar 140 is also called a vertical scrollbar.

The spreadsheet document is illustrated as document 150 in FIG. 1. The document 150 comprises a single table TA, for which a subset is presented as part of the subset 160 of the document 150. By using the scrollbars 130 and/or 140 the subset of the table TA that is presented in the document area 110 is changed based on the resulting subset 170 in the visible document area of the document 150.

It is frequently desired to use a table header 180 for the table TA, e.g., in order to denote the columns of table TA. Depending on the subset of the document 150 that is presented in the document area 110, this table header 180 might not be visible. In some implementations of spreadsheet programs the table header 180 can also move within the document area 110. For example, this is the case when the document 150 contains additional data that is not entirely represented in table TA. In a special case the document 150 can contain multiple tables. A single table is then often called a sheet. In the prior art, only one sheet is presented by a single spreadsheet program in a visible document area.

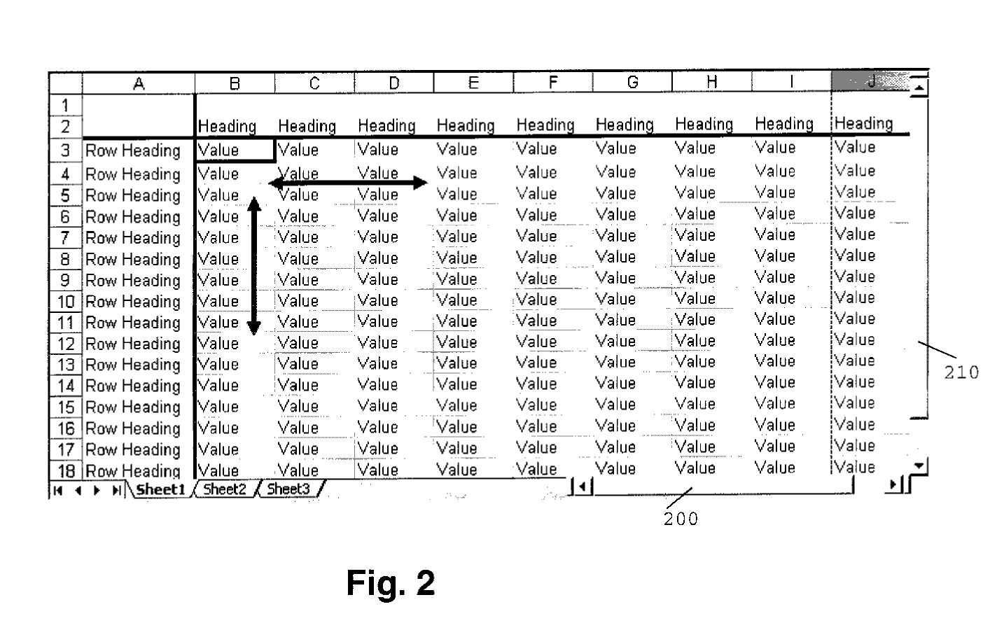

FIG. 2 provides a more detailed visual representation for a table in a spreadsheet document. The scrollbars 200 and 210 can be used to control the visible area of the table. The visible area is given here by the rows 1 to 18 and the columns A to J. The table header is given by row 2. In addition to a table header, also a row header is used. The row header is given by column A. Some spreadsheet programs allow pinning the table header and/or the row header to a fixed position within the visible document area. However, all known spreadsheet programs allow pinning these headers only for a single table. Especially, it is then not possible to present multiple sheets in the visible document area all at once, while the visible area of the sheets can be controlled all at once by use of the scrollbars 200 and 210.

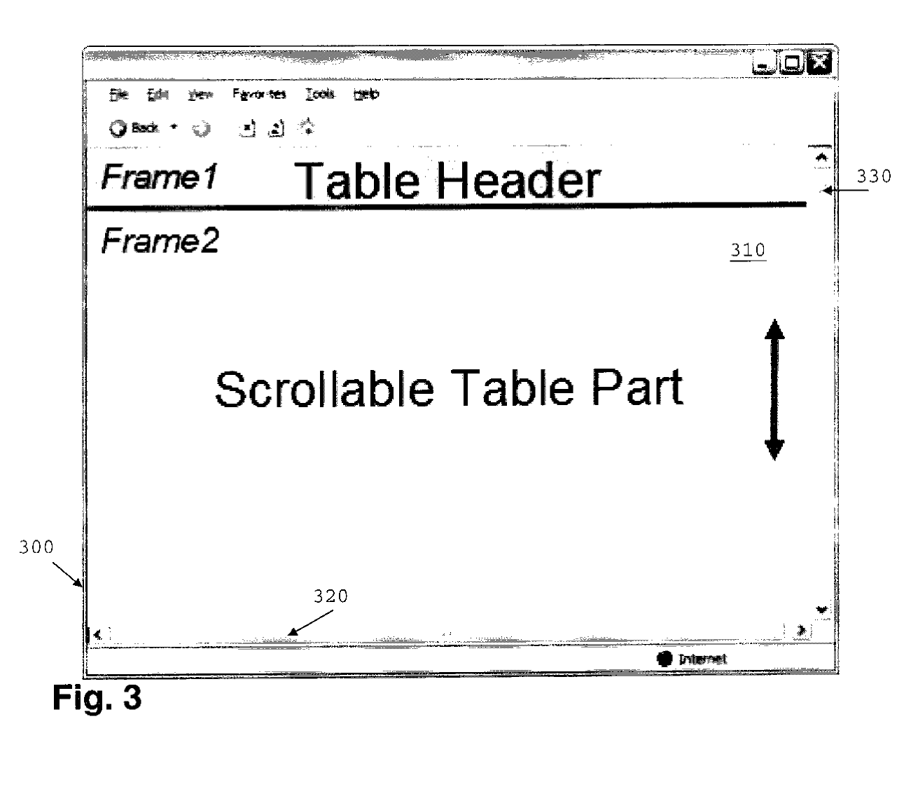

Browsers are computer programs that provide graphical representations on a computer screen for one or multiple HTML documents. FIG. 3 shows a browser window 300 with a document area 310 that provides a graphical representation for an HTML document. The visible document area of the HTML document presented in the document area 310 can be controlled by the scrollbars 320 and 330.

The document area 310 is divided in two document segments, where each segment is associated to a different HTML frame contained in the HTML document: Frame1 and Frame2. Especially, Frame1 and Frame2 can be visible representations of subsets of further HTML documents, which are referenced as files within the HTML document. It is also possible, that Frame1 is defined as a header within the HTML document. In that case, Frame1 will also remain fixed in the document area when using the scrollbars 320 and 330. This way it is possible to implement a table header that remains on a fixed position within the document area 310, whereas the table content visible in the document area 310 can be moved row by row.

Most browsers support JavaScript, a scripting language. JavaScript code segments embedded or included by referencing files within an HTML document are then interpreted by the browser. Using JavaScript code, a browser can perform tasks on an HTML document that are not possible by HTML alone. This can be achieved by interacting with the DOM (Document Object Model), a description how an HTML document is represented in a tree structure. DOM provides an object oriented application programming interface that allows parsing HTML or XML into a well defined tree structure and operating on its content. Standardized interfaces to the DOM were specified by the W3C (World Wide Web Consortium). This standard is called the W3C DOM and is platform and language independent.

Java applets are software components delivered in the form of Java bytecode. HTML documents can reference Java applet files. In most browsers they are then executed in a sandbox by using a Java virtual machine (a virtualized environment executed by a computer platform), preventing them from accessing local data. Java bytecode is the form of instructions that the Java virtual machine executes. Often the Java bytecode is generated by Java language compilers from Java programming language code. Compilers for other programming languages can also create Java bytecode. Java itself is an object-oriented programming language.

Via JavaScript and/or Java applets is it possible to embed spreadsheet applications or just tables within HTML documents. This way it is possible to present multiple spreadsheets/tables at once. However, by simply embedding multiple spreadsheet applications the different spreadsheets cannot be controlled all at once by use of a single scrollbar. Similar technologies are for example Macromedia Flash and Microsoft ActiveX controls.

### Sliding Table Headers

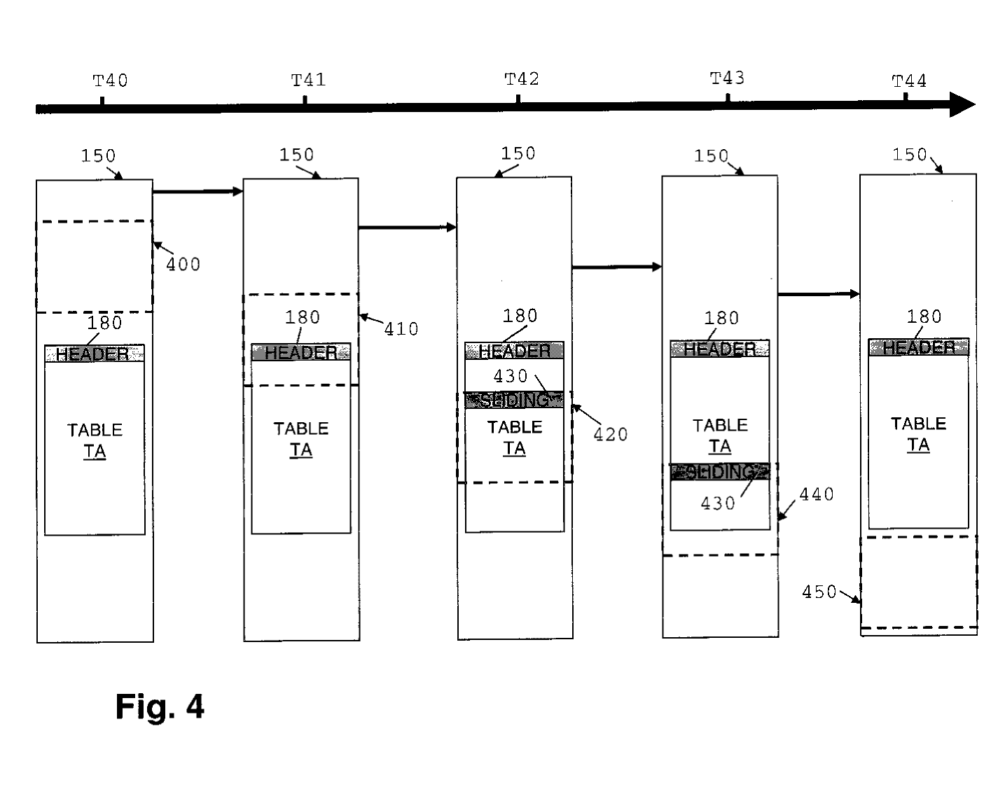

The document 150 from FIG. 1 is also shown in FIG. 4, which illustrates a sequence of subsets of the document 150 presented in a visible document area at different points in time. Neither table TA nor a subset of table TA are part of the subset 400 of the document 150 that is presented in the visible document area at the time T40. Consequently, there is also no need to present the table header 180 of the table TA. At the time T41 the subset 410 of the document 150 is presented in the visible document area. Also the table header 180 is presented using prior art methods.

At the time T42 the subset 420 of the document 150 is presented in the visible document area. The subset 420 comprises a subset of the table TA. Using prior art methods, the table header 180 cannot be presented in the visible document area as it is not part of the subset 420. According to the invention, now a sliding table header 430 presents the same information as a presentation of the table header 180 in case it would be part of the subset 420. In a preferred embodiment, the sliding table header 430 is presented at the top of the visible document area at the time T42.

At the time T43 the subset 440 of the document 150 is presented in the visible document area. The subset 440 comprises a subset of the table TA. Using prior art methods, the table header 180 cannot be presented in the visible document area as it is not part of the subset 440. According to the invention, the sliding table header 430 presents the same information as a presentation of the table header 180 in case the table header 180 would be part of the subset 440. In a preferred embodiment, the sliding table header 430 is presented at the top of the visible document area at the time T43.

At the time T44 the subset 450 of the document 150 is presented in the visible document area. The subset 440 does not comprise the table TA or a subset of the table TA. As in the prior art, the table header 180 and the sliding table header 430 are not presented in the visible document area.

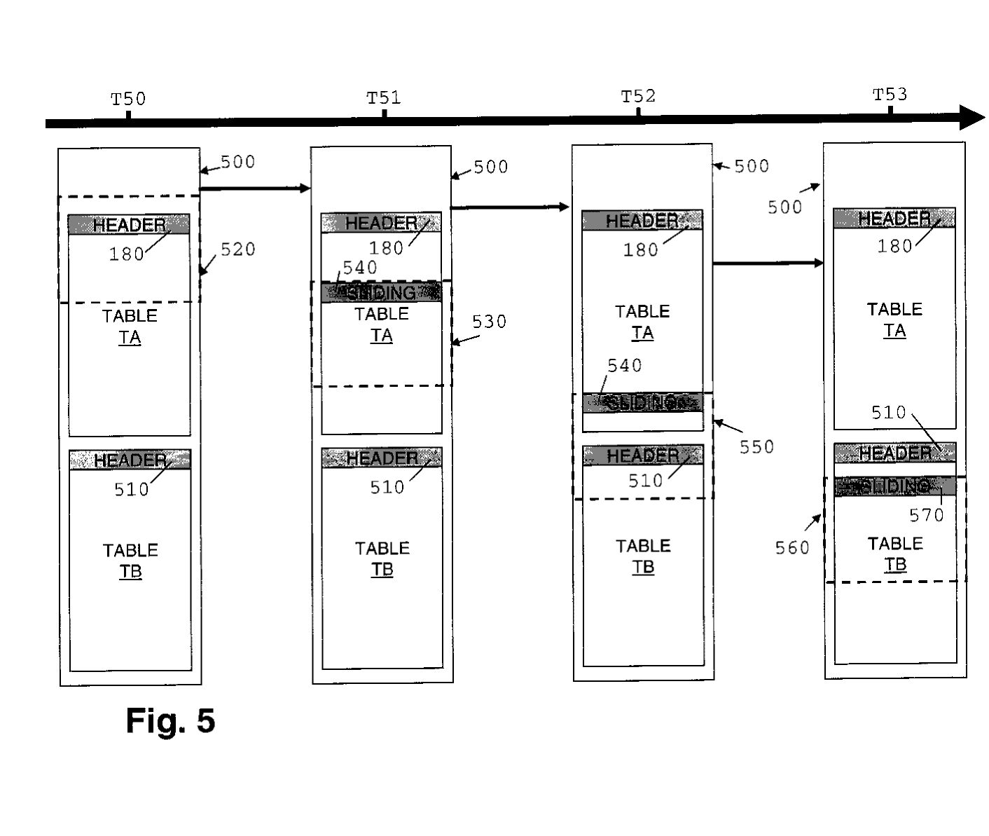

FIG. 5 illustrates a sequence of subsets of a document 500 presented in a visible document area at different points in time. The document 500 comprises two tables, the table TA shown in FIGS. 1 and 4, and table TB. Table TB comprises a table header 510. At the time T50 the subset 520 of the document 500 is presented in the visible document area. The subset 520 comprises a subset of the table TA including the table header 180, but the subset 520 does not comprise a subset of the table TB nor the entire table TB. Therefore, the table header 180 can be presented in the visible document area using prior art methods. The table header 510 does not need to be presented in the visible document area.

At the time T51 the subset 530 of the document 500 is presented in the visible document area. The subset 530 comprises a subset of the table TA, but it does not comprise the table header 180. Further, the subset 530 does neither comprise the table TB nor a subset of the table TB. Therefore, the table header 510 does not need to be presented in the visible document area. Using prior art methods, the table header 180 cannot be presented in the visible document area. According to the invention, now a sliding table header 540 presents the same information as a presentation of the table header 180 in case the table header 180 would be part of the subset 530. In a preferred embodiment, the sliding table header 540 is presented at the top of the visible document area at the time T51.

At the time T52 the subset 550 of the document 500 is presented in the visible document area. The subset 550 comprises a subset of the table TA and a subset of the table TB. The subset 550 does not comprise the table 180, but it comprises the table header 510. Using prior art methods, the table header 510 can be presented in the visible document area, but the table header 180 cannot be presented in the visible document area. According to the invention, the sliding table header 540 presents the same information as a presentation of the table header 180 in case the table header 180 would be part of the subset 550. In a preferred embodiment, the sliding table header 540 is presented at the top of the visible document area at the time T52.

At the time T53 the subset 560 of the document 500 is presented in the visible document area. The subset 560 does not comprise table TA or a subset of table TA. The subset 560 comprises a subset of table TB but not the table header 510. Table header 180 does not need to be presented in the visible document area, but table header 510 cannot be presented in the visible document area using prior art methods. According to the invention, the sliding table header 570 presents the same information as a presentation of the table header 510 in case the table header 510 would be part of the subset 560. In a preferred embodiment, the sliding table header 540 is presented at the top of the visible document area at the time T53.

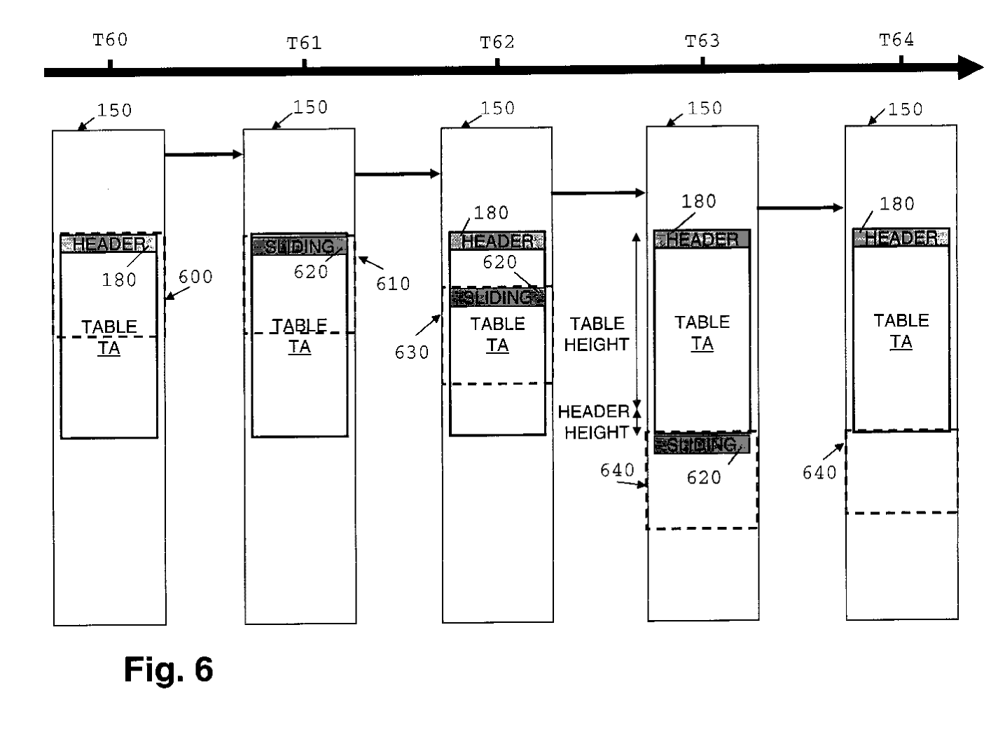

The document 150 from FIGS. 1 and 4 is also shown in FIG. 6, which illustrates a sequence of subsets of the document 150 presented in a visible document area at different points in time. Especially, the sequence illustrates under which circumstances a sliding table header has to be shown. At the time T60 the subset 600 is presented in a visible document area. The table header 180 of table TA is contained completely within the subset 600. Therefore, there is no need for a sliding table header.

At the time T61 the subset 610 of the document 150 is presented in the visible document area. The table header 180 is not completely part of the subset 610. Therefore, a sliding table header 620 is presented in the visible document area. In a preferred embodiment, the sliding table header 620 is presented at the top of the visible document area at the time T61.

At the time T62 the subset 630 of the document 150 is presented in the visible document area. The table header 180 is not even partially contained in the subset 630, but it comprises a part of the table TA. Therefore, the sliding table header 620 is presented in the visible document area. In a preferred embodiment, the sliding table header 620 is presented at the top of the visible document area at the time T62.

At the times T63 and T64 the subset 640 of the document 150 is presented in the visible document area. The table TA is not even partially contained in the subset 640. Starting at time T60 and continuing until time T64 the subsets 600, 610, 630, and 640 of the document 150 presented in the visible document area describe a (vertical) movement within the document 150 that can be controlled by a scrollbar. During this movement, different rows of the table TA are presented. Also FIGS. 4 and 5 describe such movements through the documents 150 and 500 respectively.

In these movements, sliding table headers appear at a certain point in time in the visible document areas and move then relative through the document as long as a part of the tables is contained within the subsets of the documents that are presented in the visible document areas. A sliding table header disappears from a visible document area when the table moves out from a visible document area for which the table header is associated with. Various options are possible for how long a sliding table header is presented in a visible document area once a table has been moved out.

### Implementation

A method in accordance with the present invention can be implemented as a computer program executed on a computer system. A simple example is to add sliding table headers to the presentation of HTML documents comprising multiple tables with associated table headers. The document can then be extended to use JavaScript code implementing sliding table headers. When the document is processed by a browser, a sliding table header of a table is displayed in the visible document area of the browser as long as a part of the table is presented.

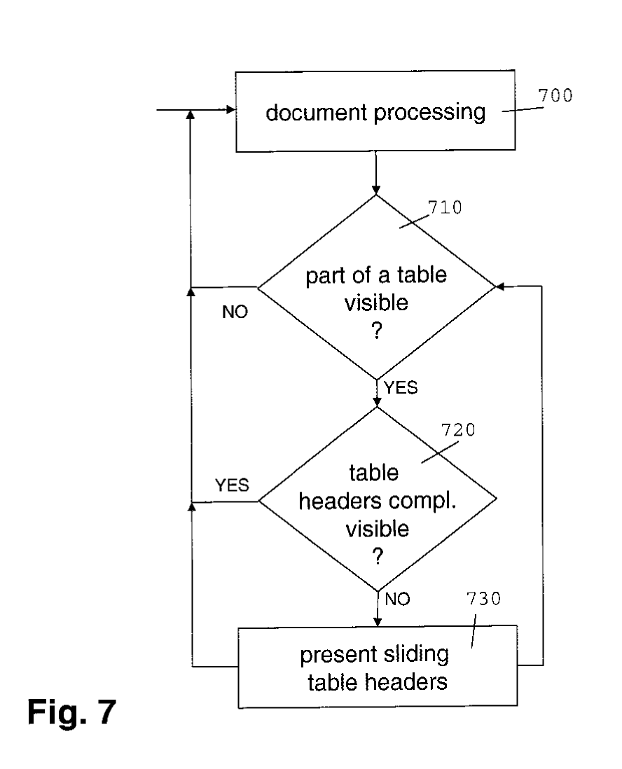

FIG. 7 illustrates a flow chart for steps of a method in accordance with the invention. This method is used when a document is processed by a computer program. In step 700 the visible document area of the computer program is modified by a computer user by using scrollbars or keys of a computer keyboard for example. Such modifications are often called scrolling of a document. Besides scrolling, other actions such as user actions can result in modifications of the visible document area. The clicking of a button of the computer program or a browser document link are examples for such user actions. But also internal events in the computer or events triggered by computer programs executed on the computer can create such actions.

In step 710 it is determined whether a part of a table contained in the document is to be presented in the visible document area. If not, then the document is processed as usual; for example it can be scrolled as in the prior art. If parts of tables are to be presented in the visible document area, then in step 720 it is determined for every affected table, if their table headers (if available at all) are completely contained in the subset of the table that is to be presented. If a table header of a table is completely contained in said subset, then this table can be processed as usual. Otherwise, a sliding table header is presented for this table in step 730.

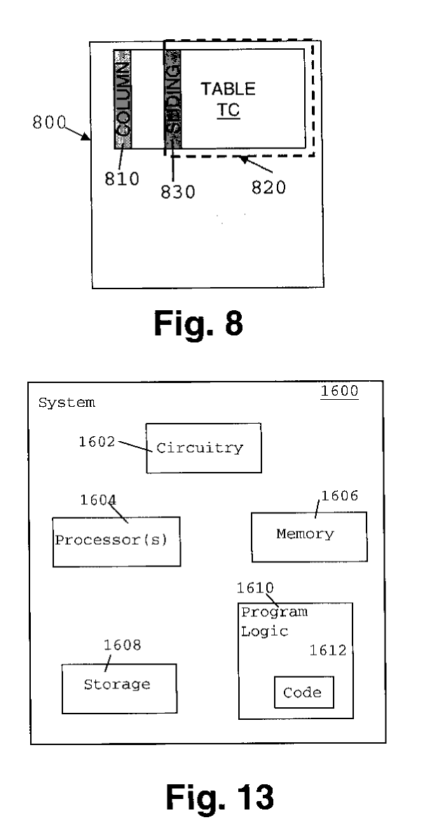

A person skilled in the art would understand that, instead of a sliding table header, also a sliding table column can be introduced. FIG. 8 shows a document 800 which is processed by a computer program. The document 800 comprises a table TC. The column 810 is intended to be displayed on a fixed vertical position but scrolled horizontally. This means that by vertical scrolling of the document 800 (by use of a vertical scrollbar for example), the table TC moves column by column within the visible document area except for the column 810. But when the document 800 is scrolled horizontally (by use of a horizontal scrollbar for example), the table TC and the column 810 is moved row by row.

In FIG. 8 the subset 820 of the document 800 that is presented in the visible document area does not comprise the column 810. Therefore, according to the invention, a sliding column 830 is presented in order to implement the fixed vertical position for the column 810 in the visible document area. In a preferred embodiment, the sliding column 830 is presented in the leftmost position in the visible document area.

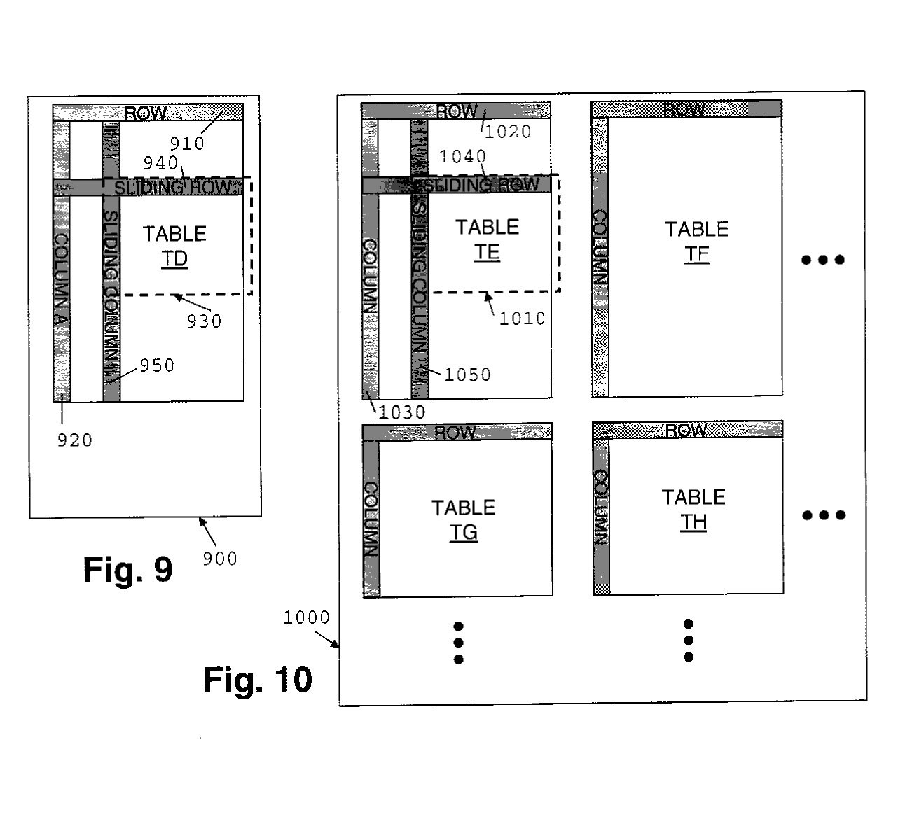

It would also be understood by a person skilled in the art that sliding table headers can be generalized to sliding rows. FIG. 9 shows a document 900 comprising a table TD. A row 910 and a column 920 of table TD are attributed in the document 900 as “fixed”. A subset 930 of the document 900 is presented in a visible document area of a computer program processing the document 900. According to the invention, a sliding row 940 and a sliding column 950 are presented in the visible document area, as both the row 910 and the column 920 are not contained in the subset 930. In a preferred embodiment of the invention, the sliding row 940 is presented in the top position of the visible document area, and the sliding column 950 is presented in the leftmost position of the visible document area.

It would further be understood by a person skilled in the art, that sliding table headers, sliding table rows, and sliding table columns can be also be used when multiple tables are comprised in a document and are presented at the same time in a visible document area of a computer program. Such a scenario is illustrated in FIG. 10. There, a document 1000 comprises four tables TE, TF, TG, and TH. A subset 1010 of the document 1000 is presented in a visible document area of a computer program processing the document 1000. No subsets of the tables TF, TG, and TH are contained in the subset 1010 of the document 1000.

The subset 1000 does not contain the row 1020 and the column 1030 of table TE, which are attributed as “fixed” in the document 1000. According to the invention, a sliding row 1040 and a sliding column 1050 is presented in the visible document area. In a preferred embodiment of the invention, the sliding row 1040 and the sliding column 1050 are presented in an area that is directly connected to the area used for the presentation of the subset of table TE, which is contained in the subset 1010.

According to the invention, rectangular shapes are either presented or not presented in a visible document area of a computer program processing a document. These shapes are representations of table headers, table rows, or table columns. When a subset of a table is presented in the visible document area, then a table header, table row, or table column will be presented when it is attributed as “fixed” in the document. The attribute “fixed” can be added to an element of a document using well known methods. A convenient method for a computer user is to use an interactive graphical user interface of a computer program processing the document.

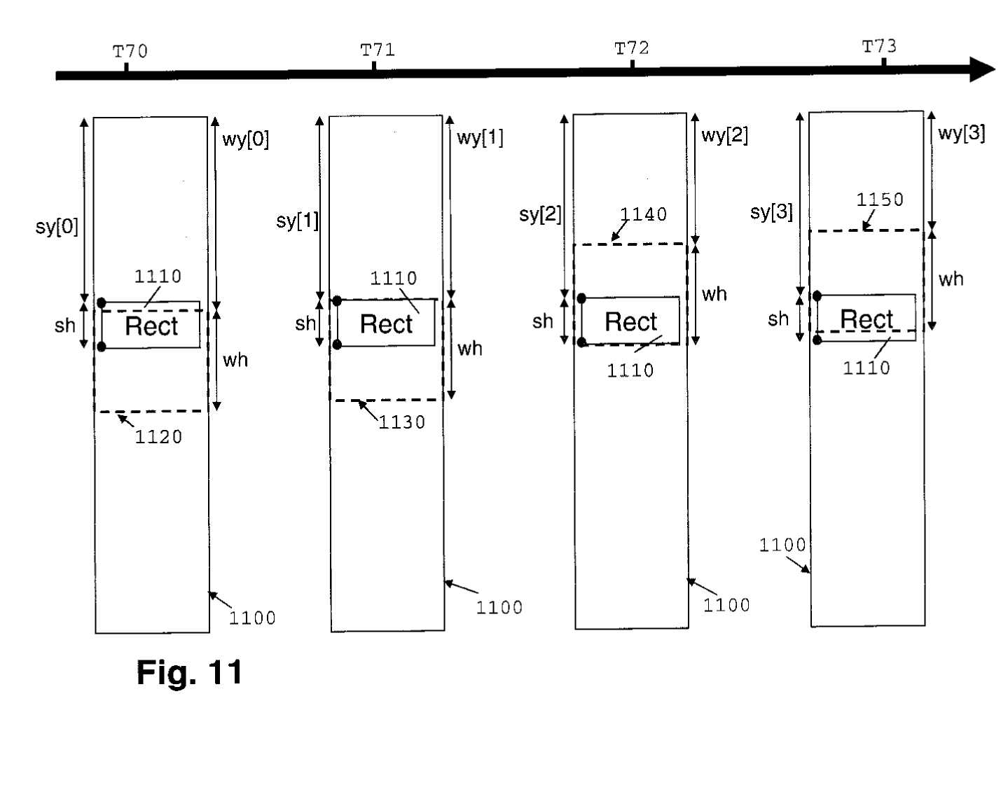

FIG. 11 shows a document 1100 comprising data 1110 that is represented in form of a rectangular shape in a visible document area of a computer program processing the document 1100. At different points in time, it is possible that a different subset of the document 1100 is presented in the visible document area. For FIG. 11, the following sequence of subsets is illustrated: At the time T70 the subset 1120 is presented; at the time T71 the subset 1130 is presented; at the time T72 the subset 1140 is presented; at the time T73 the subset 1150 is presented.

At the times T70 to T73 the rectangular shape is partially or completely contained in the visible document area as the data 1110 is partially or completely contained in the subsets 1120 to 1150. For FIG. 11, the rectangular shape representing the data 1110 moves only vertically within the visible document area. This scrolling can be caused by a computer user driving a vertical scrollbar for the visible document area for example.

Only in order to simplify the description it is assumed that the visible document area is a collection of planar shapes within a rectangle. The rectangular shape representing the data 1110 has the height sh and the rectangle of the visible document area has the height wh, which do not change over time. However, it is not essential for the invention that these widths are fixed. When the data at the beginning of the document 1100 is presented in the visible document area, this is called that “the computer program is at the top of the document”.

When the document 1100 is scrolled from the top to a particular subset, the sequence of subsets that were presented but are no more presented in the visible document area describes a virtual rectangular shape. For the subsets 1120 to 1150 the height of the associated virtual rectangular shape is wy[0], wy[1], wy[2], and wy[3] respectively. For the subsets of the data 1110 presented in the visible document area at the times T70 to T73 and contained in the subsets 1120 to 1150 respectively, the height of the associated virtual rectangular shape is sy[0], sy[1], sy[2], and sy[3] respectively.

The heights of the rectangles and rectangular shapes can be used to determine if a table header or a table is completely contained at a certain point in time in a subset of a document that is presented in a visible document area of a computer program processing a document.

For FIG. 11 the following two conditions (i) and (ii) must be fulfilled for i=0, . . . , 3 when the data 1110 is a table header, for the table header to be completely represented in the visible document area:

(i) sy[i]>wy[i]
(ii) sy[i]+sh<wy[i]+wh

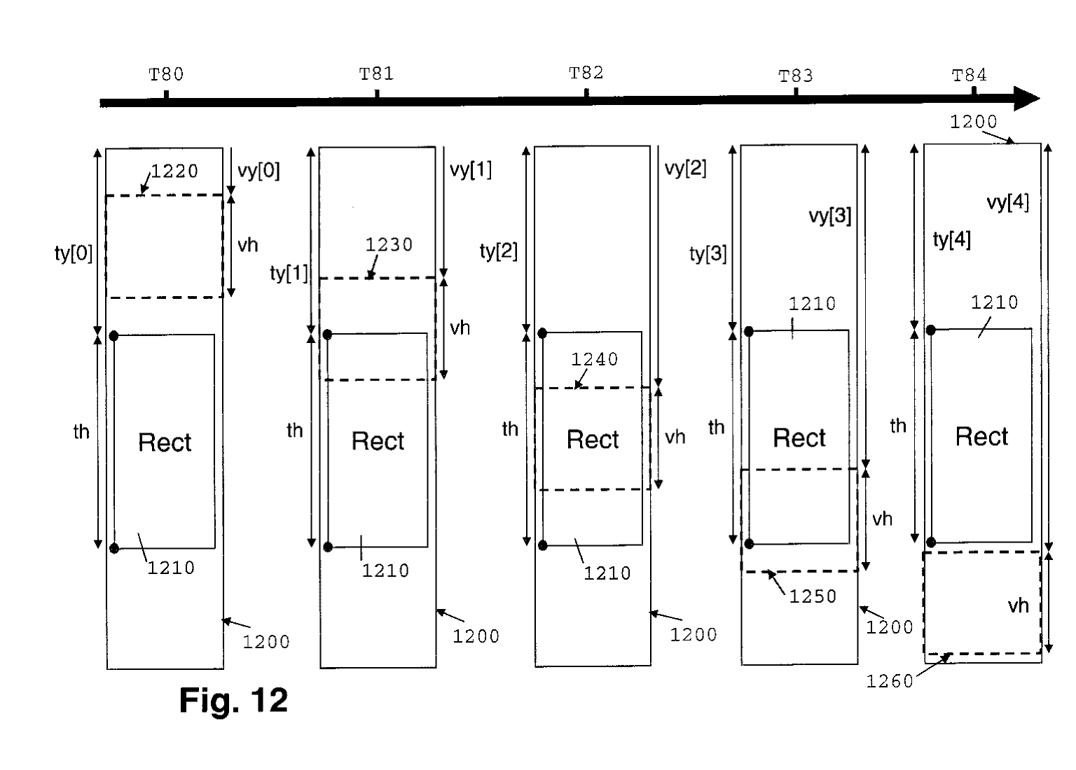

FIG. 12 shows a document 1200 comprising data 1210 that is represented in form of a rectangular shape in a visible document area of a computer program processing the document 1200. At different points in time, it is possible that a different subset of the document 1200 is presented in the visible document area. For FIG. 12, the following sequence of subsets is illustrated: At the time T80 the subset 1220 is presented; at the time T81 the subset 1230 is presented; at the time T82 the subset 1240 is presented; at the time T83 the subset 1250 is presented; at the time T84 the subset 1260 is presented.

In order to simplify the description it is assumed that the visible document area is a collection of planar shapes delimited by a rectangle. The rectangular shape representing the data 1210 has the height th and the rectangle of the visible document area has the height vh, which do not change over time. However, it is not essential for the invention that these widths are fixed. When the document 1200 is scrolled from the top to a particular subset, the sequence of subsets that were presented but are no more presented in the visible document area describes a virtual rectangular shape.

For the subsets 1220 to 1260 the height of the associated virtual rectangular shape is vy[0], vy[1], vy[2], vy[3], and vy[4] respectively. For the subsets of the data 1210 presented in the visible document area at the times T80 to T74 and contained in the subsets 1220 to 1260 respectively, the height of the associated virtual rectangular shape is ty[0], ty[1], ty[2], ty[3], and ty[4] respectively.

For FIG. 12 the following two conditions (iii) and (iv) must be fulfilled for i=0, . . . , 4 when the data 1210 is a table, for the table to be partially or completely represented in the visible document area:

(iii) ty[i]<vy[i]+vh
(iv) ty[i]+th>vy[i]

### ADDITIONAL EMBODIMENT DETAILS

The described techniques may be implemented as a method, apparatus or article of manufacture involving software, firmware, micro-code, hardware and/or any combination thereof. The term “article of manufacture” as used herein refers to code or logic implemented in a medium, where such medium may comprise hardware logic [e.g., an integrated circuit chip, Programmable Gate Array (PGA), Application Specific Integrated Circuit (ASIC), etc.] or a computer readable medium, such as magnetic storage medium (e.g., hard disk drives, floppy disks, tape, etc.), optical storage (CD-ROMs, optical disks, etc.), volatile and non-volatile memory devices [e.g., Electrically Erasable Programmable Read Only Memory (EEPROM), Read Only Memory (ROM), Programmable Read Only Memory (PROM), Random Access Memory (RAM), Dynamic Random Access Memory (DRAM), Static Random Access Memory (SRAM), flash, firmware, programmable logic, etc.]. Code in the computer readable medium is accessed and executed by a processor. The medium in which the code or logic is encoded may also comprise transmission signals propagating through space or a transmission media, such as an optical fiber, copper wire, etc. The transmission signal in which the code or logic is encoded may further comprise a wireless signal, satellite transmission, radio waves, infrared signals, Bluetooth, etc. The transmission signal in which the code or logic is encoded is capable of being transmitted by a transmitting station and received by a receiving station, where the code or logic encoded in the transmission signal may be decoded and stored in hardware or a computer readable medium at the receiving and transmitting stations or devices. Additionally, the “article of manufacture” may comprise a combination of hardware and software components in which the code is embodied, processed, and executed. Of course, those skilled in the art will recognize that many modifications may be made without departing from the scope of embodiments, and that the article of manufacture may comprise any information bearing medium. For example, the article of manufacture comprises a storage medium having stored therein instructions that when executed by a machine results in operations being performed.

Certain embodiments can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, certain embodiments can take the form of a computer program product accessible from a computer usable or computer readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries. Additionally, a description of an embodiment with several components in communication with each other does not imply that all such components are required. On the contrary a variety of optional components are described to illustrate the wide variety of possible embodiments.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently.

When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article. The functionality and/or the features of a device may be alternatively embodied by one or more other devices which are not explicitly described as having such functionality/features. Thus, other embodiments need not include the device itself.

FIG. 13 illustrates a block diagram of a system 1600 in which certain embodiments may be implemented. The system 1600 may include a circuitry 1602 that may in certain embodiments include a processor 1604. The system 1600 may also include a memory 1606 (e.g., a volatile memory device), and storage 1608. The storage 1608 may include a non-volatile memory device (e.g., EEPROM, ROM, PROM, RAM, DRAM, SRAM, flash, firmware, programmable logic, etc.), magnetic disk drive, optical disk drive, tape drive, etc. The storage 1608 may comprise an internal storage device, an attached storage device and/or a network accessible storage device. The system 1600 may include a program logic 1610 including code 1612 that may be loaded into the memory 1606 and executed by the processor 1604 or circuitry 1602. In certain embodiments, the program logic 1610 including code 1612 may be stored in the storage 1608. In certain other embodiments, the program logic 1610 may be implemented in the circuitry 1602. Therefore, while FIG. 13 shows the program logic 1610 separately from the other elements, the program logic 1610 may be implemented in the memory 1606 and/or the circuitry 1602.

Certain embodiments may be directed to a method for deploying computing instruction by a person or automated processing integrating computer-readable code into a computing system, wherein the code in combination with the computing system is enabled to perform the operations of the described embodiments.

At least certain of the operations illustrated in the figures may be performed in parallel as well as sequentially. In alternative embodiments, certain of the operations may be performed in a different order, modified or removed.

Furthermore, many of the software and hardware components have been described in separate modules for purposes of illustration. Such components may be integrated into a fewer number of components or divided into a larger number of components. Additionally, certain operations described as performed by a specific component may be performed by other components.

The data structures and components shown or referred to in the figures and the description are described as having specific types of information. In alternative embodiments, the data structures and components may be structured differently and have fewer, more or different fields or different functions than those shown or referred to in the figures.

Therefore, the foregoing description of the embodiments has been presented for the purposes of illustration and description. It is not intended to be exhaustive or to limit the embodiments to the precise form disclosed. Many modifications and variations are possible in light of the above teaching.

1. A computer-implemented method of modifying and presenting document data, wherein some subsets of said document data are marked as document elements, and for some of said document elements some of their subsets are marked as sub-elements, the method comprising the steps of:
marking some of said sub-elements as fixed elements; selecting at least some of said document data for presentation;
for each of said document elements, determining if it is at least partially selected;
if a document element is at least partially selected, determining if it comprises a fixed element and determining if this comprised fixed element is completely selected;
if said comprised fixed element is not completely selected, creating a sliding element;
completely selecting said sliding element instead of any part of said comprised fixed element; and
presenting the selected data, whereby a presentation of a sliding element comprises a complete presentation of the associated fixed element.

2. The method of claim 1, wherein:
said document elements comprise table data or spreadsheet data; and
wherein said sub-elements comprise rows or columns.

3. The method of claim 1, wherein a sliding element is presented in a fixed position relative to the presentation of its associated document element.

4. The method of claim 2, wherein a sliding element is presented in a fixed position relative to the presentation of its associated document element.

5. The method of claim 1, wherein said marking of fixed elements can be controlled interactively by a computer user or controlled automatically by software code portions executed on a computer.

6. The method of claim 2, wherein said marking of fixed elements can be controlled interactively by a computer user or controlled automatically by software code portions executed on a computer.

7. The method of claim 3, said marking of fixed elements can be controlled interactively by a computer user or controlled automatically by software code portions executed on a computer.

8. The method of claim 4, wherein said marking of fixed elements can be controlled interactively by a computer user or controlled automatically by software code portions executed on a computer.

9. A computer program loadable into the internal memory of a computer system and comprising software code portions for performing by operation on the computer system, comprising:
marking some of said sub-elements as fixed elements;
selecting at least some of said document data for presentation; for each of said document elements, determining if it is at least partially selected;
if a document element is at least partially selected, determining if it comprises a fixed element and determining if this comprised fixed element is completely selected;
if said comprised fixed element is not completely selected, creating a sliding element;
completely selecting said sliding element instead of any part of said comprised fixed element; and
presenting the selected data, whereby a presentation of a sliding element comprises a complete presentation of the associated fixed element.

10. The computer program of claim 9, comprising a spreadsheet program.

11. The computer program of claim 9, comprising a browser program.

12. The computer program of claim 10, comprising a browser program.

13. The computer program of claim 9, whereby the computer program is at least partially contained within said document data.

14. The computer program of claim 10, whereby the computer program is at least partially contained within said document data.

15. The computer program of claim 11, whereby the computer program is at least partially contained within said document data.
